(19) United States
(12) Patent Application Publication
(10) Pub. No.: US 2014/0349272 A1
(43) Pub. Date: Nov. 27, 2014

(54) METHOD FOR EVALUATING PERFORMANCE OF A USER ON AN E-LEARNING SYSTEM

(71) Applicant: LoudCloud Systems Inc., Dallas, TX (US)

(72) Inventors: Manoj Kutty, Dallas, TX (US); Anil Vishwanath Sonkar, Andheri (IN); Amit Bansal, Mumbai (IN); Abhijit Das, Dallas, TX (US); Bibekananda Pahi, Keonjhar (IN)

(73) Assignee: LoudCloud Systems Inc., Dallas, TX (US)

(21) Appl. No.: 13/898,652

(22) Filed: May 21, 2013

(51) Int. Cl. G09B 5/08

(52) U.S. Cl. CPC G09B 5/08
USPC 434/362

(57) ABSTRACT

Method and system for evaluating performance a user on an e-learning system is disclosed. A capturing module is configured to capture activity data related to a plurality of entities from the user in un-structured form wherein the activity data comprises a transactional data and a log data. An ETL module is configured to process the transactional data and the log data to derive a structured data. After processing, the ETL module is further configured to load the structured data into a structured database and further determines an evaluation index for the user by performing statistical analysis on the structured data. Based on the statistical analysis, the ETL module is further configured to compare the evaluation index with a benchmark value pre-defined for the evaluation index by other user. Moreover an analytics module is configured to generate a report and an alert for the other user to evaluate the performance of the user based on the comparison.

### TECHNICAL FIELD

The present subject matter described herein, in general, relates to e-learning systems, and more particularly to e-learning systems for evaluating performance of a user.

### BACKGROUND

With the enormous growth of e-learning systems over the past years, the e-learning systems have already become an integral part of the learning tools used by educational organizations, Government institutions and other institutions. The e-learning systems redefines the teaching/learning processes and the overall learning environment by facilitating electronic/technological support learning, teaching through virtual classroom, self-paced learning, asynchronous learning or instructor-led synchronous learning. The e-learning systems further facilitates instructors, teachers, mentors or any other online tutor to educate students or observers remotely in a structured manner and to conduct an online assessment test. Thereafter, the e-learning systems enable the instructors to evaluate the performance of the students based on their response on the assessment test by assigning score, grade and marks etc.

However, the evaluation of the performance based on the assigned score, grade or marks may not be sufficient to evaluate the overall performance of the students on the e-learning systems. For example, the students on the e-learning systems may also participate in other learning activities such as forums, assignments or quizzes etc. The parameters associated with these other learning activities may create a significant impact on the overall performance of the students, and hence may be considered while evaluating the performance. Such parameters may include quality of content, time-spent, sequence of navigation, plagiarism check, and participation level of each student in forums/quizzes.

### SUMMARY

This summary is provided to introduce aspects related to systems and methods for evaluating performance of at least one user on an e-learning system and the aspects are further described below in the detailed description. This summary is not intended to identify essential features of the claimed subject matter nor is it intended for use in determining or limiting the scope of the claimed subject matter.

In one implementation, an e-learning system for evaluating performance of ‘at least one user’ hereinafter referred as a ‘user’ using an Extraction, Transformation and Load (ETL) process is disclosed, wherein the user may be a student or an instructor. The e-learning system comprises a processor and a memory coupled to the processor wherein the processor is capable of executing a plurality of modules. The plurality of modules further comprises a capturing module, an ETL module and an analytics module. The memory further comprises a system database and a structured database. In one aspect of the disclosure, the capturing module is configured to capture activity data related to a plurality of entities from the user on the e-learning system, wherein the activity data comprises a transactional data and a log data that gets stored in a system database. The plurality of entities may be an assignment, a class, a forum, a quiz, a course, a grade-book, a program. The ETL module is configured to extract the transactional data and the log data stored in an un-structured form from the system database. The ETL module is further configured to process the transactional data and the log data to derive a structured data wherein the structured data is associated to at least one entity from the plurality of entities. Moreover, the ETL module further loads the structured data into one or more tables of a structured database. In one aspect, the transactional data comprises an assignment score, quiz score, discussion question score, substantive post of the at least one user, grade assigned in quizzes and number of likes on posts etc. The log data comprises time spent on assignments, time spent on forums, time spent on quizzes, time spent on discussion questions, sequence of navigations and time spent on assignments etc. The ETL module is further configured to compute ‘at least one evaluation index’ hereinafter referred as ‘evaluation index’ for the user by performing statistical analysis on the structured data. In one aspect, the evaluation index may be a performance index, a mandatory activity index, a non-mandatory activity index, a social collaboration index, an academic workload index, an activity index or a content index. The ETL module is further configured to compare the evaluation index with a benchmark value pre-defined for the evaluation index by at least one other user. In one aspect, the at least one other user may be an instructor, an administrator, a mentor etc. Subsequent to the comparison, the analytics module is enabled to generate at least one report and at least one alert for the at least one other user to evaluate the performance of the user. In addition to the at least one report and the at least one alert, the system may further facilitate the instructor to discuss with the student regarding the performance of the student through an online discussion forum that is integrated with the system.

In another implementation, a method for evaluating performance of at least one user on an e-learning system using an Extraction, Transformation and Load (ETL) process is disclosed. The method initially captures activity data related to a plurality of entities from at least one user on the e-learning system, wherein the activity data comprises a transactional data and a log data stored in an un-structured form that gets stored in a system database. After capturing the activity data, the method extracts the transactional data and the log data stored in an un-structured form from the system database. The method further processes the transactional data and the log data to derive a structured data wherein the structured data is related to at least one entity from the plurality of entities. Based on the transformation, the method further loads the structured data into one or more tables of a structured database. Upon loading the transactional data and the log data, the method further determines at least one evaluation index for the at least one user by performing statistical analysis on the structured data. Based on the statistical analysis, the method further compares the at least one evaluation index with a benchmark value pre-defined for the at least one evaluation index by at least one other user. Upon comparison, the method further generates at least one report and at least one alert for the at least one other user. The at least one report and the at least one alert is generated to evaluate the performance of the at least one user based on the comparison of the at least one evaluation index with the benchmark value. In addition to the at least one report and the at least one alert, the method may further facilitate the instructor to discuss with the student regarding the performance of the student through an online discussion forum.

In yet another implementation, a computer program product having embodied thereon a computer-executable instructions for evaluating performance of at least one user on an e-learning system using an Extraction, Transformation and Load (ETL) process is disclosed. The computer program product comprises instructions for capturing activity data related to a plurality of entities from at least one user on the e-learning system, wherein the activity data comprises a transactional data and a log data captured in an un-structured form that gets stored in a system database. The transactional data and the log data stored in an un-structured form is extracted from the system database and processed to derive a structured data wherein the structured data is associated to at least one entity from the plurality of entities. In one aspect, the transactional data and the log data may be loaded into one or more tables of a structured database. Further a statistical analysis is performed on the structured data to determine at least one evaluation index for the at least one user. Based on the statistical analysis the at least one evaluation index is compared with a benchmark value pre-defined for the at least one evaluation index by at least one other user. Upon comparison, at least one report and at least one alert may be generated for the at least one other user to evaluate the performance of the at least one user. In addition to the at least one report and the at least one alert, the program code may further facilitate the instructor to discuss with the student regarding the performance of the student through an online discussion forum.

### BRIEF DESCRIPTION OF THE DRAWINGS

The foregoing summary, as well as the following detailed description of embodiments, is better understood when read in conjunction with the appended drawings. For the purpose of illustrating the disclosure, there is shown in the present document example constructions of the disclosure, however, the disclosure is not limited to the specific methods and apparatus disclosed in the document and the drawings:

The detailed description is described with reference to the accompanying figures. In the figures, the left-most digit(s) of a reference number identifies the figure in which the reference number first appears. The same numbers are used throughout the drawings to refer like features and components.

FIG. 1 illustrates a network implementation of an e-learning system for evaluating performance of at least one user is shown, in accordance with an embodiment of the present subject matter.

FIG. 2 illustrates the e-learning system, in accordance with an embodiment of the present subject matter.

FIG. 3 illustrates detailed working of the components of the e-learning system, in accordance with an embodiment of the present subject matter.

FIG. 4 illustrates a method for evaluating performance of at least one user on an e-learning system, in accordance with an embodiment of the present subject matter.

The figures depict various embodiments of the present disclosure for purposes of illustration only. One skilled in the art will readily recognize from the following discussion that alternative embodiments of the structures and methods illustrated herein may be employed without departing from the principles of the disclosure described herein.

### DETAILED DESCRIPTION

Some embodiments of this disclosure, illustrating all its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any systems and methods similar or equivalent to those described herein can be used in the practice or testing of embodiments of the present disclosure, the exemplary, systems and methods are now described. The disclosed embodiments are merely exemplary of the disclosure, which may be embodied in various forms.

Various modifications to the embodiment will be readily apparent to those skilled in the art and the generic principles herein may be applied to other embodiments. For example, although the present disclosure will be described in the context of a e-learning system and method for evaluating performance of ‘at least one user’ hereinafter referred as a ‘user’ on an e-learning system using an Extraction, Transformation and Load (ETL) process, one of ordinary skill in the art will readily recognize that the method and system can be utilized in any situation where there is need to evaluate the performance of a user through the e-learning or any online learning systems. Thus, the present disclosure is not intended to be limited to the embodiments illustrated, but is to be accorded the widest scope consistent with the principles and features described herein.

System(s) and method(s) for evaluating performance of a user on the e-learning system using the Extraction, Transformation and Load (ETL) process are described. The user may be a student, an instructor or an administrator accessing the e-learning system to perform various activities such as attempting an assignment, attending a virtual class, attempting a collaborative forum, attempting a quiz, attempting a course, attempting a grade-book, attending a program or the like. The various activities performed by the student may be tracked in the form of activity data in an un-structured form, wherein the activity data comprises a transactional data and a log data. The transactional data and the log data associated with the various activities as aforementioned may be captured and stored in a system database. The transactional data and the log data may be then extracted from the system database to process the transactional data and the log data to derive a structured data using at least one Extraction, Transformation and Load (ETL) process. In one aspect, the transactional data may be related to at least one activity from a plurality of activities such as an assignment score, quiz score, discussion question score, substantive post of the at least one user, grade assigned in quizzes, number of likes on posts, and number of posts in the forum etc. On the other hand, the log data may be time spent while performing the at least one activity on the e-learning system. For example, the log data may comprise time spent on assignments, time spent on forums, time spent on quizzes, time spent on discussion questions, sequence of navigations, and time spent on attempting assignments etc. After processing the transactional data and the log data to derive the structured data, the structured data may be then loaded into one or more data tables of a structured database.

In order to evaluate the performance of the student, the structured data may be then retrieved from the structured database and statistically analyzed to compute an evaluation index based on student performance and engagement levels. In one aspect, the evaluation index may be a performance index, a mandatory activity index, a non-mandatory activity index, a social collaboration index, an academic workload index, an activity index or a content index. In one another aspect of the disclosure, the performance index, the mandatory activity index, the non-mandatory activity index, the social collaboration index may be associated with the performance evaluation of the student whereas the academic workload index, the activity index or the content index may be associated with the performance evaluation of the instructor. Further, the evaluation index computed may be then compared with a pre-defined benchmark value, to determine whether the performance of the student is upgraded or degraded. In one aspect the pre-defined benchmark value may be defined by the instructor. Upon comparing the evaluation index with the benchmark value, a report and an alert may be generated to notify the instructor about the performance of the student. In one aspect, the alert may be generated in the form of e-mail, message, and prompt about degrading performance of the ‘student’. Further the e-learning system generates a report in the form of line/bar-graph, heat maps, cross tabulation or tables depicting the performance of the student that may be statistically represented for the reference of the instructor.

The e-learning system may be then adapted to display the report or the alert on a dashboard based on the role of the user. The dashboards support multi-level reporting systems based on the role of the user. For example the ‘administrator’ may view the report depicting the performance of the instructor or the performance of the student whereas the ‘instructor’ can only view the report depicting the performance of the ‘student’. Moreover the dashboard further facilitates the ‘administrator’ or the ‘instructor’ to compare the performance of individual students on the e-learning system.

While aspects of described system and method for evaluating performance of at least one user on an e-learning system using an Extraction, Transformation and Load (ETL) process may be implemented in any number of different computing systems, environments, and/or configurations, the embodiments are described in the context of the following exemplary system. Thus, the following more detailed description of the embodiments of the disclosure, as represented in the figures and flowcharts, is not intended to limit the scope of the disclosure, as claimed, but is merely representative of certain examples of presently contemplated embodiments in accordance with the disclosure.

The presently described embodiments will be best understood by reference to the drawings, wherein like parts are designated by like numerals throughout. Moreover, flowchart and block diagrams in the Figures illustrate the architecture, functionality, and operation of possible implementations of systems and methods according to various embodiments of the present disclosure. In this regard, each block in the flowchart or block diagrams may represent a module, segment, or portion of code, which comprises one or more executable instructions for implementing the specified logical function(s).

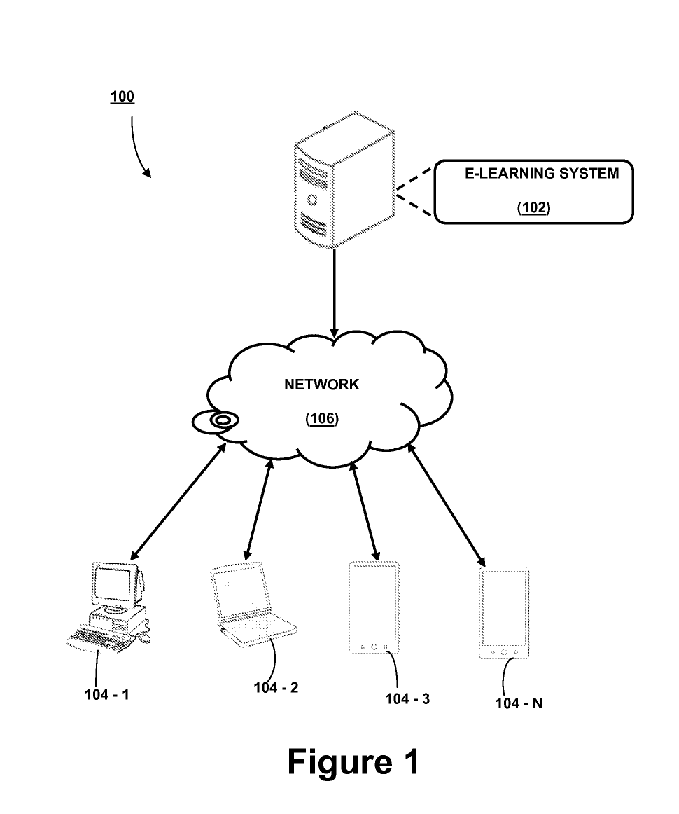

Referring now to FIG. 1, a network implementation 100 of an e-learning system 102 for evaluating performance of at least one user using an Extraction, Transformation and Load (ETL) process while the at least one user is performing at least one entity from a plurality of entities on the e-learning system 102 is illustrated, in accordance with an embodiment of the present subject matter. In one embodiment, the e-learning system 102 may be provided for evaluating performance of the at least one user. In order to evaluate the performance, the e-learning system 102 captures activity data related to a plurality of entities from at least one user on the e-learning system 102, wherein the activity data captured may be stored in a system database 220. In one aspect, the activity data comprises a transactional data and a log data related to a plurality of entities on the e-learning system 102. The transactional data and the log data may be stored in the system database 220 The e-learning system 102 further extracts the transactional data and the log data from the system database 220 in order to process the transactional data and the log data to derive a structured data using at least one Extraction, Transformation and Load (ETL) process. In one aspect, the structured data may be associated to at least one entity from the plurality of entities. After processing, the structured data may be loaded into one or more tables of a database. The e-learning system 102 further computes at least one evaluation index for the at least one user by performing statistical analysis on the structured data. Upon computing the at least one evaluation index, the e-learning system 102 further compares the at least one evaluation index with a benchmark value pre-defined for the at least one evaluation index wherein the benchmark value may be pre-defined by at least one other user. Based on the comparison, the e-learning system 102 may generate at least one report and at least one alert for the at least one other user to evaluate the performance of the at least one user based on the comparison of the at least one evaluation index with the benchmark value. In addition to the at least one report and the at least one alert, the system 102 may further facilitates the at least one other user to discuss with the at least one user regarding the performance of the student through an online discussion forum that may be integrated with the system 102.

Although the present subject matter is explained considering that the e-learning system 102 is implemented on a server, it may be understood that the e-learning system 102 may also be implemented in a variety of computing systems, such as a laptop computer, a desktop computer, a notebook, a workstation, a mainframe computer, a server, a network server and the like. It will be understood that the e-learning system 102 may be accessed by multiple users through one or more user devices 104-1, 104-2 . . . 104-N, collectively referred to as user 104 hereinafter, or applications residing on the user devices 104. Examples of the user devices 104 may include, but may be not limited to, a portable computer, a personal digital assistant, a handheld device, and a workstation. The user devices 104 may be communicatively coupled to the e-learning system 102 through a network 106.

In one implementation, the network 106 may be a wireless network, a wired network or a combination thereof. The network 106 can be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

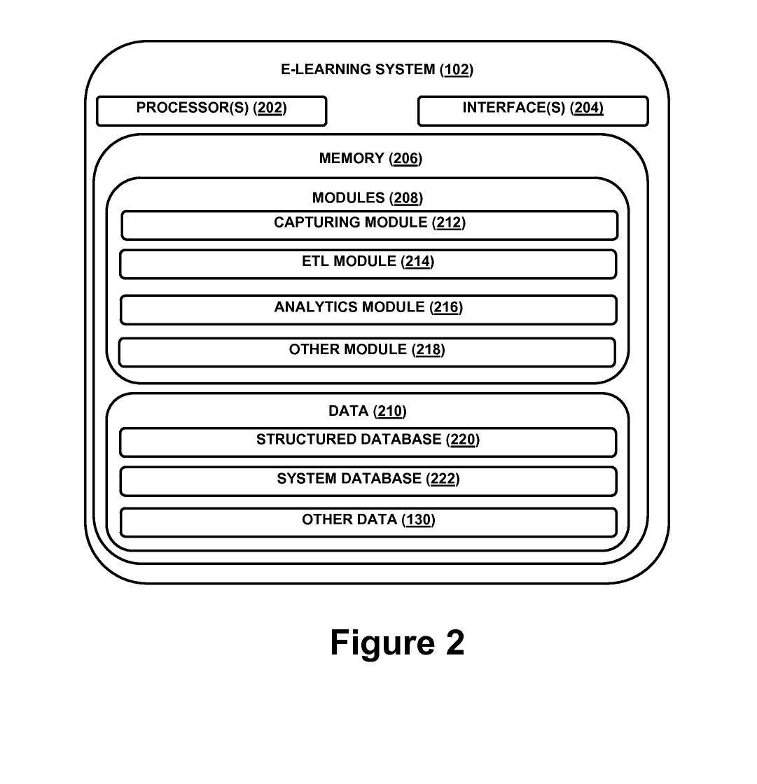

Referring now to FIG. 2, the e-learning system 102 is illustrated in accordance with an embodiment of the present subject matter. In one embodiment, the e-learning system 102 may include at least one processor 202, an input/output (I/O) interface 204, and a memory 206. The at least one processor 202 may be implemented as one or more microprocessors, microcomputers, microcontrollers, digital signal processors, central processing units, state machines, logic circuitries, and/or any devices that manipulate signals based on operational instructions. Among other capabilities, the at least one processor 202 may be configured to fetch and execute computer-readable instructions stored in the memory 206.

The I/O interface 204 may include a variety of software and hardware interfaces, for example, a web interface, a graphical user interface, and the like. The I/O interface 204 may allow the e-learning system 102 to interact with a user directly or through the user devices 104. Further, the I/O interface 204 may enable the e-learning system 102 to communicate with other computing devices, such as web servers and external data servers (not shown). The I/O interface 204 can facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium or computer program product known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 206 may include modules 208 and data 210.

The modules 208 include routines, programs, objects, components, data structures, etc., which perform particular tasks or implement particular abstract data types. In one implementation, the modules 208 may include a capturing module 212, an ETL module 214, an analytics module 216 and other module 218. The other module 218 may include programs or coded instructions that supplement applications and functions of the e-learning system 102.

The data 210, amongst other things, serves as a repository for storing data processed, received, and generated by one or more of the modules 208. The data 210 may also include a structured database 220, a system database 222 and other data 130. The other data 130 may include data generated as a result of the execution of one or more modules in the other module 218.

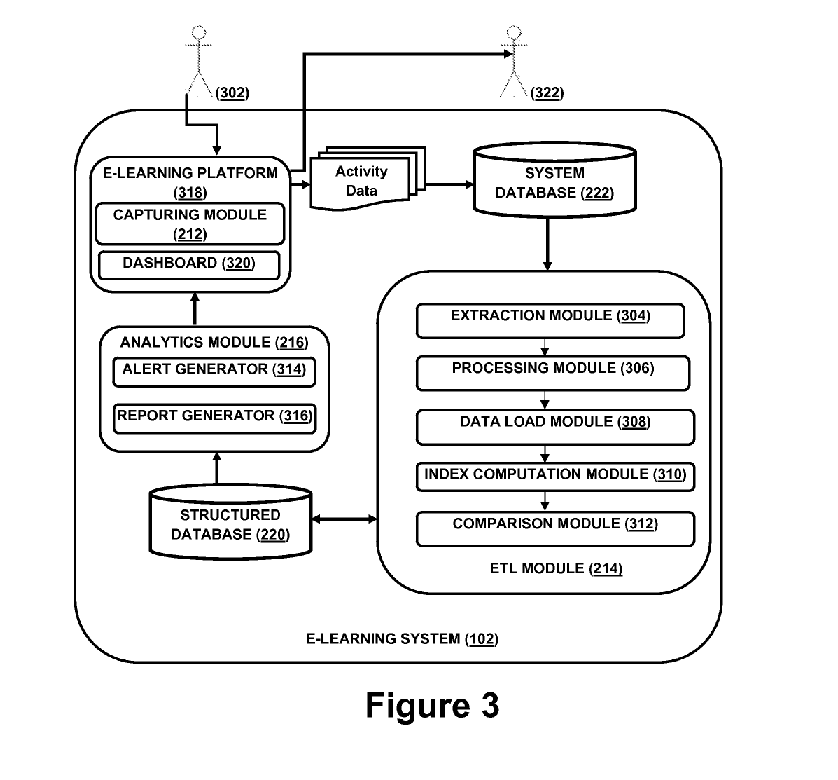

In one implementation, at first, a user may use the user device 104 to access the e-learning system 102 via the I/O interface 204. The user may register using the I/O interface 204 in order to use the e-learning system 102. The working of the e-learning system 102 may be explained in detail in FIG. 3 explained below. The e-learning system 102 may be used for evaluating the performance of at least one user on the e-learning system.

Referring to FIG. 3, a detailed working of the components of the e-learning system 102 along is illustrated, in accordance with an embodiment of the present subject matter. In one implementation, in order to evaluate the performance ‘at least one user’ hereinafter referred as ‘user’, an e-learning platform 318 enables the user 302 to perform activities on a plurality of entities on the e-learning system 102. In one aspect, the user 302 may be a ‘student’ or an ‘instructor’. While the user 302 may be engaged in performing the activities on the plurality of entities, the capturing module 212 in the e-learning platform 318 may be adapted to capture activity data associated with the plurality of entities in an un-structured form, wherein the activity data comprises a transactional data and a log data. In one aspect, the plurality of entities may comprise an assignment, a class, a forum, a quiz, a course, a grade-book, a program or combinations thereof. The activity data captured may be further stored in the system database 222 in an un-structured form. In one aspect, the transactional data depicts the data captured while the user 302 may be performing activities on at least one entity from the plurality of entities and the log data may be time spent by the user 302 while performing at least one entity from the plurality of entities on the e-learning system 102. In one aspect, the transactional data comprises includes but limited to, an assignment score, quiz score, discussion question score, substantive post of the at least one user, grade assigned in quizzes, number of likes on posts, number of posts in the forum. On the other hand, the log data depicts the time spent on the plurality of entities. In one aspect, the log data includes but not limited to, time spent on assignments, time spent on forums, time spent on quizzes, time spent on discussion questions, time spent on attempting assignments and sequence of navigations etc.

After capturing the transactional data and the log data in the un-structured form, the ETL module 214 may be configured to process the transactional data and the log data by retrieving the transactional data and the log data from the system database 222. In one embodiment, the ETL module 214 further comprises an extraction module 304, a processing module 306, a data load module 308, an index computation module 310 and a comparison module 312. In one aspect, the extraction module 304 may be adapted to extract the transactional data and the log data from the system database 222. The transactional data and the log data extracted from the system database 222 may be then processed to derive a structured data by using the processing module 306. In one aspect the processing module 306 may be configured to perform the transformation using one or more data normalization process or any other Extraction, Transformation and Load process know in the art.

After processing the transactional data and the log data which derives the structured data, the data load module 308 may be adapted to load the structured data associated to at least one entity from the plurality of entities into one or more tables of the structured database 220. In one aspect the one or more tables may be in form of a dimension table containing data related to the plurality of entities such users, programs, course, class, assignments, quiz, forum, fact table containing the time spent or the behavior of the user 302 such as likes, quiz submitted, assignment submitted score, grades on the at least one entity from the plurality of entities, consolidated table contacting data points such as time spent per week, attendance per week etc or the like. Upon loading the structured data into the one or more data tables of the structured database 220, the index computation module 310 may be adapted to compute ‘at least one evaluation index’ hereinafter referred as ‘evaluation index’ in order to evaluate the performance of the user 302. The evaluation index may be computed by retrieving the structured data related to the at least one activity of the user 302 from the structured database 220 and thereby performing statistical analysis on the structured data. In one aspect, the performance of the user 302 may be evaluated based on different types of the evaluation index such as a performance index, a mandatory activity index, a non-mandatory activity index, a social collaboration index, academic workload index, an activity index and a content index. In one another aspect of the disclosure, the performance index, the mandatory activity index, the non-mandatory activity index and the social collaboration index may be associated with the student whereas the academic workload index, the activity index and the content index may be associated with the instructor.

In one embodiment, the evaluation index may be computed by performing statistical analysis on the parameters associated with the structured data including but may be not limited to assignment score, discussion question score, substantive post of the at least one user, grade assigned in quizzes, number of likes on posts, and number of posts in the forum along with the time spent by the user on each of these parameters. Each of the evaluation index as aforementioned may be associated with one or more parameters. For example, the performance index may utilize one or more parameters such as score on assignment, score on quiz, and score on discussion question. The mandatory activity index utilizes the one or more parameters such as graded quiz attempted, assignments submitted, discussion questions with at least one post, total time spent on books, total time spent on syllabus, average time spent on graded quizzes attempted, total time spent on discussion questions. The non-mandatory activity index utilizes the one or more parameters such as time spent/click on related material; practice quizzes attempted, annotations, posts over and above the required graded posts in discussion questions, topics in question to instructor forums, number of posts of instructors student is flagging, topics in individual forum with students. The social collaboration index utilizes the one or more parameters as annotations shared, files shared with other users through file cabinet, replies on question to instructor forum, topics not self initiated.

In one implementation, in order to determine the evaluation index based on the above parameters for each of the evaluation indices, the statistical analysis may be performed by following the steps comprising handling missing data, data normalization and calculation of index, which are further elaborated as below:

### Handling Missing Data:

As disclosed, the evaluation index may be calculated based on the plurality of parameters. The parameters may be sorted at class level for a plurality of students in the class on the basis of degree of population of these parameters. The parameters which may be 75% populated may be considered for the computation of the evaluation index. That is, the system 102 may be configured for selecting only the parameters having less than or equal to 25% missing data. Initially, all parameters available may be considered, however, after a pre-defined time interval, based on the logic of handling of missing data, only few set of parameters that have only 25% missing data for the Index calculation. In one embodiment, since the activity data may be dynamic in nature, the parameters selected for calculation may vary depending on the day or time at which the parameter values for particular activity may be monitored. Thus, dynamic set of parameters may be utilized for calculation of the Indices. The missing data may be tracked based on the assessment data, submission data, and availability of assignment data for the students in the class. When the score of the parameter being analyzed for missing data is equal to zero or null, the parameter may be considered to be the parameter having the missing data.

In one embodiment, the parameter may be assigned zero value when:

I) Assessment data is available, at least one student has data populated, submission date for the assignment <Sysdate (current date of the system 102) and there is no availability of re-assignment to the students of the class, and

II) Assessment data is available, no student has score or data populated, submission date for the assignment <Sysdate (current date of the system 102), the number of submissions=0 & total assignments >0 and there is no availability of re-assignment to the students of the class

Similarly, in one embodiment, the parameter may be assigned null value when:

I) Assessment data is available, at least one student has data populated, submission date for the assignment >=Sysdate (current date of the system 102),

II) Assessment data is available, no student has score or data populated, submission date for the assignment >=Sysdate (current date of the system 102),

III) No assessment data is available, and

IV) Assessment data is available, at least one student has data populated, submission date for the assignment <Sysdate (current date of the system 102) and there is availability of re-assignment to the students of the class

In an embodiment, based on the aforementioned analysis of missing data for each of the parameters, a few set of parameters may be selected for calculating the evaluation indices. Each of the parameters selected may be assigned with weights by the index computation module 310 depending on the requirements. The weights assigned to the parameters for calculating a specific evaluation index may be such that the sum of all the weights is ‘one’. Specifically, considering an example of a index ‘A’ being calculated based on four parameters A1, A2, A3 and A4 having the 75% data being populated and less than 25% missing data, the index computation module 310 may assign weights W1, W2, W3 and W4, such that W1+W2+W3+W4=1. However, there may be scenarios, wherein the sum of the weights of the parameters to be analyzed for calculating the evaluation indices may be greater than or less than one. In such scenarios, the system 102 may be adapted to re-calibrate the weights of the parameters, and thereby assign new weights to each of the parameters.

For example, in one embodiment, if the sum of weights of the parameters selected for calculating a specific index may be greater or less than 1, then the new weight of the parameter may be calculated by using the below formula:

New weight=(Old Weight−((Total of Old Weight−1)/No. of parameters) (I)

In one exemplary embodiment, consider following parameters may be being selected by the system 102 for calculating of Student Performance Index as illustrated in Table I. It can be observed from the table I that, the summation of weights being assigned to each of the parameters satisfying missing data criteria (<=25%) is greater than one. Thus, for each of the parameter, new weight may be being assigned using the above formula I. In this case, the number of parameters is 6, total of old weight is 1.350. Therefore, the re-calibration of weights for each of the parameters is being achieved by assigning new weight as below:

New Weight=Old weight−((1.350−1)/6),

i.e. New Weight=Old weight−0.058

The new weight calibrated for each of the parameters is being displayed in the table I.

TABLE I

| Parameters satisfying % missing criteria | Old Weight | New Weight |
|---|---|---|
| Score on Assignment | 0.400 | 0.342 |
| Score on quiz | 0.175 | 0.116666667 |
| Score on Discussion Question | 0.175 | 0.116666667 |
| # of substantive posts of user | 0.250 | 0.191666667 |
| Peer points in group assignment | 0.175 | 0.116666667 |
| Participation score | 0.175 | 0.116666667 |
| Total (A) | 1.350 | 1 |

In another exemplary embodiment, consider following parameters may be being selected by the system 102 for calculating of Student Performance Index as illustrated in Table II. It is evident from the table II that, the summation of weights being assigned to each of the parameters satisfying missing data criteria (<=25%) is less than one. Thus, for each of the parameter, new weight is being assigned using the above formula I. In this case, the number of parameters is 3, total of old weight is 0.750. Therefore, the re-calibration of weights for each of the parameters is being achieved by assigning new weight as below:

New Weight=Old weight−((0.750−1)/3)

i.e. New Weight=Old weight−(−0833)

The new weight calibrated for each of the parameters is being displayed in the table II.

TABLE II

| Parameters satisfying % missing criteria | Old Weight | New Weight |
|---|---|---|
| Score on Assignment | 0.400 | 0.483 |
| Score on quiz | 0.175 | 0.258333333 |
| Score on Discussion Question | 0.175 | 0.258333333 |
| Total | 0.750 | 1 |

Thus, the system 102 may be configured for re-calibration of weights assigned, such that the summation of the weights assigned may be equal to one.

Further, subsequent to handling of missing data, the index computation module 310 may be configured to proceed with the next step, i.e. data normalization.

In one embodiment, before obtaining the normalized value for each of the parameters, the value of each of the parameters may be subjected to outlier analysis. In the outlier analysis, the parameter value deviating from the cluster of values, both at the minimum and the maximum level, may be brought to a pre-defined value of acceptable range. The outlier analysis may be necessary and significant, since the activity data from where the parameter value may be derived may be dynamic, and there may be high possibilities of parameter values being deviating from the acceptable values. These parameter values may be rectified by applying the outlier analysis.

### Data Normalization:

Subsequent to the outlier analysis on the parameter values, the normalized value for each of the parameters may be obtained using data normalization methods. There are two methods which may be used for normalization i.e. a Proportion method and a MIN-MAX method. In the Proportion method, the boundary points may be available while in the Min-Max method, no boundary points may be available. For the parameters where the boundary points exist, the proportion method may be used to normalize the data. In this method, transformation of the data point may be performed by dividing the boundary point i.e. the maximum possible value of the data using formula:

Transformation=(Value)±Max(Value)

For example: If a student scores (SoA) 83 on 100 in the ‘assignment’ entity, then the normalized value for score on the assignment will be 83/100=0.83. Further all the parameters may be calculated as the moving average of that particular parameter till that particular time period.

E.g.: SoA on day 3 is the average of SoA (day1−day3).

In one aspect, if there are no boundary points, then Min-Max method may be used to normalize the data. In this method, the minimum value and the maximum value may be observed. The data point may be transformed as difference of value and minimum observed value which may be further divided by the difference of maximum observed value and minimum observed value using following formula:

$$Transformation = \frac{( Value - Min ( Value ) )}{( Max ( Value ) - Min ( Value ) )}$$

For example, if the no of substantive posts of a student is 5, the Min (number of substantive posts) is 0 and Max is 10 then Number of substantive posts is (5−0)/(10−0)=0.5

### Calculation of Index Value:

In one embodiment, the calculation of index value may be obtained by multiplying the normalized values of parameters with the weights. In order to calculate student performance index and student participation index following formulations may be used:

$$( Student performance Index ) t = ( W 1 \times [ N ( SoA ) ] ) + ( W 2 \times [ N ( SoF ) ] ) + ( w 3 \times [ N ( SoQ ) ] ) + ( W 4 \times [ N ( Posts ) ] )$$

$$and \\ ( Student participation Index ) t = ( 0.25 \times [ N ( Q T I ) ] ) + ( 0.25 \times [ N ( Ann ) ] ) + ( 0.25 \times [ N ( FoO ) ] ) + ( 0.25 \times [ N ( Tt ) ] )$$

At class level, the parameters may be calculated at the class level which may be the average of the parameter across the class. For example, the value of score on assignment in a class may be average of score on assignment of all the students in that class. Once the parameters may be calculated for all the classes in the above mentioned way, the data points may be transformed in the following mentioned format. The values of average and standard deviation across classes may be calculated for all the parameters. Based on the calculation each point may be given a rank based on the following scheme:

If[value<(average−stdev)];then value=1

If[value>(average+stdev)];then value=3

If{[value>(average−stdev)]AND[value<(average+stdev)]};then value=2

After this transformation, the indices may be calculated using the below mentioned formulae:

(Class performance Index)t={(0.4×[N(SoA)])+(0.175×[N(SoF)])+(0.175×[N(SoQ)])+(0.25×[N(Posts)])}×(10/3)

(Class participation Index)t={(0.25×[N(QTI)])+(0.25×[N(Ann)])+(0.25×[N(FoO)])+(0.25×[N(Tt)])}×(10/3)

(Course performance Index)t={(0.4×[N(SoA)])+(0.175×[N(SoF)])+(0.175×[N(SoQ)])+(0.25×[N(Posts)])}×(10/3)

(Course participation Index)t={(0.25×[N(QTI)])+(0.25×[N(Ann)])+(0.25×[N(FoO)])+(0.25×[N(Tt)])}×(10/3)

(Program performance Index)t={(0.4×[N(SoA)])+(0.175×[N(SoF)])+(0.175×[N(SoQ)])+(0.25×[N(Posts)])}×(10/3)

(Program participation Index)t={(0.25×[N(QTI)])+(0.25×[N(Ann)])+(0.25×[N(FoO)])+(0.25×[N(Tt)])}×(10/3)

The above calculations determine the performance evaluation index of the student and may be based on specific parameters. Each parameter may be related to activity performed by the student online. For calculating class index, average of each parameter may be calculated at class level. While computing values for course level parameters class level parameters may be aggregated and similarly at program level course parameters may be aggregated. For each parameter, average and standard deviation may be calculated. Further, average−standard deviation and average+standard deviation may be calculated for each parameter. Mode pertaining to each week/class/course may be also calculated for respective index. Also, after calculation mode, no other normalization/proportion method may be applied on it. If there may be two modes in the data then maximum value of mode may be taken into consideration.

Rule for Ranking of parameters: If value of parameter is below the difference of average and standard deviation then, the system 102 assigns rank ‘1’, as illustrated below:

if x<Avg(x)−Stdev(x) then rank=1

For Example x=21Avg(x)=26.64Stdev(x)=2.91

Avg(x)−Stdev(x)=23.72

x<23.72˜rank=1

If value of parameter is in between in the difference of average and standard deviation and average and standard deviation together, then the system 102 assigns rank ‘2’ as illustrated below:

if Avg(x)−Stdev(x)<x and Avg(x)+Stdev(x)>x then rank=2

For Example x=24.58 Avg(x)=24.8 Stdev(x)=2.8

Avg(x)−Stdev(x)=22.00

Avg(x)+Stdev(x)=27.6

22<x<27.6˜rank=2

If value of parameter is greater than the average and standard deviation together, then the system 102 assigns rank ‘3’ as illustrated below:

if x>Avg(x)+Stdev(x) then rank=3

For Example x=41.4 Avg(x)=31.5 Stdev(x)=4.7

Avg(x)+Stdev(x)=36.2

x>36.2˜rank=3

Dividing parameters as per indices—After ranking, attributes/parameters may be segregated as per the type of indices along with their respective ranks calculated.

### Calculating Indices:

For calculation of indices, each rank obtained may be multiplied with weights assigned for each variable and then applying summation principle. The Value derived as a result of summation is the evaluation index value.

$${CR}_{( i )} = {\sum }_{i = 1}^{n} {W}_{i} * {X}_{i}$$

$$Index = {CR}_{( i )} * 10 / 3$$

Xᵢ: Rank of the ith parameter Wi: Weight of the ith parameter CR(i): Content Ranking Index of ith class/instructor

### For Example:

CR₍₁₎=0.4*3+0.175*3+0.175*1

CR₍₁₎=1.9

Based on the above statistical analysis performed, the comparison module 312 may be further adapted to compare the evaluation index with a benchmark value. In one embodiment, the benchmark value may be pre-defined for the evaluation index by ‘at least one other user’ herein after referred as ‘other user’, wherein the other user may be an instructor or an administrator. The comparison module 312 further enables the other user 322 to customize the benchmark value for each of the evaluation index as aforementioned. In one embodiment, the benchmark value may be deduced for the evaluation index using at least one of the following methods:

1. T-test: lower limit method.

2. Tailed method.

3. Failure rate based benchmark.

Upon comparing the at least one evaluation index with the benchmark value, if it is determined that the evaluation index is less than the benchmark value, the comparison module 312 may be adapted to generate an alert and a report, depicting the degrading performance of the user 302 for the reference of the other user 322. On the other hand, if it is determined that the evaluation index is greater than the benchmark value, the comparison module 312 generates the alert and the report, depicting the upgrading performance of the user 302 for the reference of the other user 322. The alert and the report generated may be further stored in the structured database 220. The alert generation module 314 and the report generator 316 may be further adapted to retrieve the alert and the report stored in the structured database 220 respectively. After retrieving the alert and the report, the analytics module 216 may be further adapted to display the alert and the report to the other user 322 on a dashboard 320, wherein the dashboard may be integrated with the e-learning platform 318. The other user 322 may be then enabled to access the dashboard 320 integrated with the e-learning platform 318 for evaluating the performance of the user 302. In one embodiment, the report may be generated in the form of univariate, bivariate or multivariate containing analytics graphs, heat maps, and alert messages, alert prompts etc. depicting the performance of the student that may be statistically represented for the reference of the at least one other user. In one aspect, the report further comprises a sub-report having recommendations related to the performance of the user 302. In addition the report and the alert, the system 102 further facilitate the at least one other user to discuss with the at least one user regarding the performance of the at least one user through an online discussion forum that may be integrated with the system 102. In one aspect of the disclosure, the at least one other user may be an administrator or an instructor or a mentor whereas the at least one user may be the student.

Exemplary embodiments discussed above may provide certain advantages. Though not required to practice aspects of the disclosure, these advantages may include:

1. Enabling the user to customize benchmark activities related to one or more entities on the e-learning system.

2. Enabling the course administrators, instructors to identify the performance and activity relationships of the students on the e-learning system.

3. Enabling course administrators, instructors to access in depth visual/tabular reports representing data giving “point in time” information on weekly basis, trends on activity, providing benchmarks for comparing information each student.

4. Quick actionable reference information through alerts and reports on the dashboard.

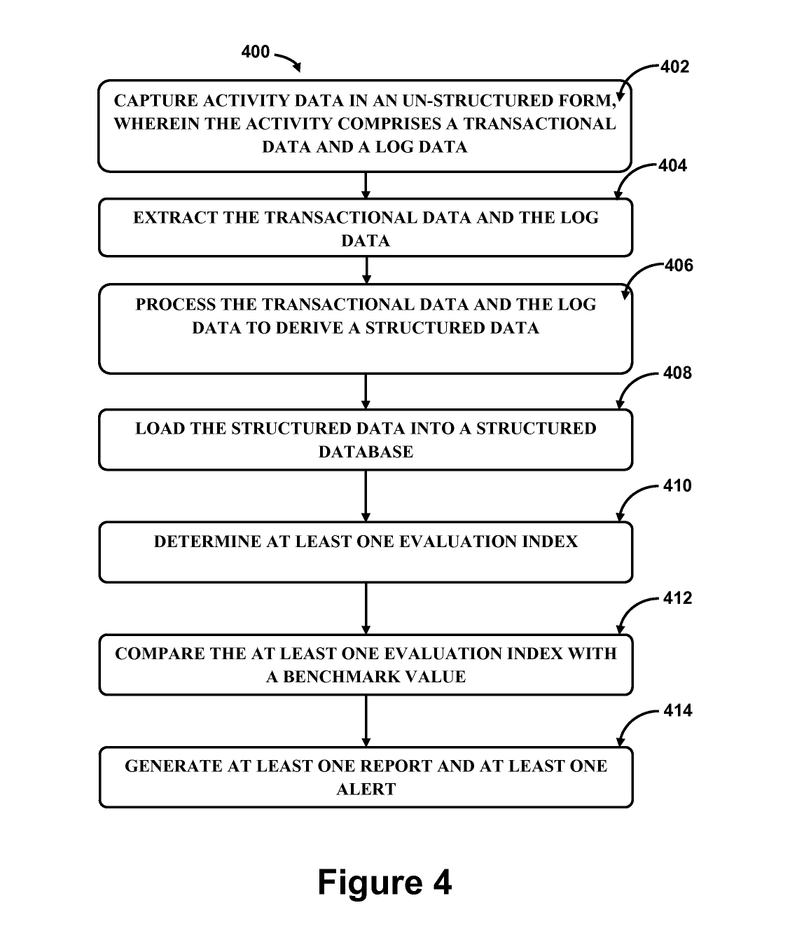

Referring now to FIG. 4, a method 400 for evaluating performance of at least one user is shown, in accordance with an embodiment of the present subject matter. The method 400 may be described in the general context of computer executable instructions. Generally, computer executable instructions can include routines, programs, objects, components, data structures, procedures, modules, functions, etc., that perform particular functions or implement particular abstract data types. The method 400 may also be practiced in a distributed computing environment where functions may be performed by remote processing devices that may be linked through the communications network 106. In a distributed computing environment, computer executable instructions may be located in both local and remote computer storage media, including memory storage devices.

The order in which the method 400 is described is not intended to be construed as a limitation, and any number of the described method blocks can be combined in any order to implement the method 400 or alternate methods. Additionally, individual blocks may be deleted from the method 400 without departing from the spirit and scope of the subject matter described herein. Furthermore, the method can be implemented in any suitable hardware, software, firmware, or combination thereof. However, for ease of explanation, in the embodiments described below, the method 400 may be considered to be implemented in the above described e-learning system 102.

At block 402, activity data related to a plurality of entities from at least one user on the e-learning system may be captured in un-structured form. In one aspect, the activity comprises a transactional data and a log data. The transactional data and the log data may be then stored in a system database 222. In one implementation, the activity data may be captured by the capturing module 212.

At block 404, the transactional data and the log data stored in the un-structured form may be extracted from the system database 222. In one implementation, the transactional data and the log data may be extracted by the ETL module 214.

At block 406, the transactional data and the log data may be processed to derive a structured data using any Extraction, Transformation and Load (ETL) process wherein the structured data may be related to at least one entity from the plurality of entities. In one implementation, the transactional data and the log data may be processed by the ETL module 214.

At block 408, the structured data may be loaded into one or more tables of a structured database 220. In one implementation, the structured data may be loaded by the ETL module 214.

At block 410, at least one evaluation index may be determined by performing statistical analysis on the structured data. In one implementation, the at least one evaluation index may be determined by the ETL module 214.

At block 412, the at least one evaluation index may be compared with a benchmark value pre-defined for the at least one evaluation index by at least one other user. In one implementation, the at least one evaluation index may be compared with the benchmark value by the ETL module 214.

At block 414, at least one report and at least one alert may be generated for the at least one other user to evaluate the performance of the at least one user based on the comparison of the at least one evaluation index with the benchmark value. In one implementation, the report and the alert may be generated by the analytics module 216.

Although implementations for methods and systems for evaluating the performance of the at least one user while performing at least one entity on the e-learning system 102 have been described in language specific to structural features and/or methods, it is to be understood that the appended claims are not necessarily limited to the specific features or methods described. Rather, the specific features and methods are disclosed as examples of implementations for evaluating the performance of the at least one user.

I/We claim:

1. A method for evaluating performance of at least one user on an e-learning system using an Extraction, Transformation and Load (ETL) process, the method comprising:
capturing, by a processor, activity data related to a plurality of entities from at least one user on the e-learning system wherein the activity data comprises a transactional data and a log data;
extracting, by the processor, the transactional data and the log data stored in an un-structured form from a system database;
processing, by the processor, the transactional data and the log data to derive a structured data;
loading, by the processor, the structured data associated to at least one entity from the plurality of entities into one or more tables of a structured database;
determining, by the processor, at least one evaluation index for the at least one user by performing statistical analysis on the structured data;
comparing, by the processor, the at least one evaluation index with a benchmark value pre-defined for the at least one evaluation index;
generating, by the processor, at least one report and at least one alert for at least one other user to evaluate the performance of the at least one user based on the comparison of the at least one evaluation index with the benchmark value.

2. The method of claim 1, wherein the at least one user may be a student, or an instructor, and wherein the at least one other user may be the instructor or an administrator.

3. The method of claim 1, wherein the plurality of entities on the e-learning system comprises an assignment, a class, a forum, a quiz, a course, a grade-book, a program or combinations thereof.

4. The method of claim 1, wherein the transactional data comprises an assignment score, quiz score, discussion question score, substantive post of the at least one user, grade assigned in quizzes, number of likes on posts, number of posts in the forum or combinations thereof.

5. The method of claim 1, wherein the log data comprises time spent on assignments, time spent on forums, time spent on quizzes, time spent on discussion questions, time spent on attempting assignments, sequence of navigations or combinations thereof.

6. The method of claim 1, wherein the at least one evaluation index includes but not limited to, performance index, mandatory activity index, non-mandatory activity index, social collaboration index, academic workload index, activity index and content index.

7. The method of claim 1, wherein the report generated may be in the form of univariate, bivariate or multivariate.

8. The method of claim 1, wherein the report may comprise a sub-report depicting recommendations related to the performance of the at least one user.

9. An e-learning system for evaluating performance of at least one user on an e-learning system using an Extraction, Transformation and Load (ETL) process, the e-learning system comprising:
a processor; and
a memory coupled to the processor, wherein the processor is capable of executing a plurality of modules stored in the memory, and wherein the plurality of module comprising:
a capturing module configured to capture activity data related to a plurality of entities from at least one user on the e-learning system, wherein the activity data comprises a transactional data and a log data;
an ETL module configured to:
extract the transactional data and the log data stored in an un-structured form from a system database;
process the transactional data and the log data to derive a structured data;
load the structured data associated to at least one entity from the plurality of entities into one or more tables of a structured database;
determine at least one evaluation index for the at least one user by performing statistical analysis on the structured data;
compare the at least one evaluation index with a benchmark value pre-defined for the at least one evaluation index to derive an evaluated score, wherein the benchmark value is retrieved from the structured database;
an analytics module configured to generate at least one report and at least one alert for at least one other user to evaluate the performance of the at least one user based on the comparison of the at least one evaluation index with the benchmark value; and
the memory further comprising:
a structured database configured to store the structured data associated to the at least one entity from the plurality of entities
the system database configured to store the activity data comprising the transactional data and the log data in the un-structured form.

10. The e-learning system of claim 9, wherein the analytics module is further configured to generate a sub-report depicting recommendations related to the performance of the at least one user.

11. The e-learning system of claim 9, wherein the report is in the form of univariate, bivariate or multivariate.

12. The e-learning system of claim 9, wherein the structured database is configured to store the transactional data such as an assignment score, quiz score, discussion question score, substantive post of the at least one user, grade assigned in quizzes, number of likes on posts, number of posts in the Forum or combinations thereof.

13. The e-learning system of claim 9, wherein the structured database is further configured to store the log data such as time spent on assignments, time spent on forums, time spent on quizzes, time spent on discussion questions, time spent on attempting assignments, sequence of navigations or combinations thereof.

14. The method of claim 9, wherein the ETL module is further configured to segregate the transactional data and the log data into one or more data tables of the structured database.

15. A computer program product having embodied thereon a computer program for evaluating performance of at least one user on an e-learning system using an Extraction, Transformation and Load (ETL) process, the computer program product comprising instructions for:
capturing activity data related to a plurality of entities from at least one user on the e-learning system, wherein the activity data comprises a transactional data and a log data;
extracting the transactional data and the log data stored in an un-structured form from a system database;
processing the transactional data and the log data to derive a structured data;
loading the structured data associated to at least one entity from the plurality of entities into one or more tables of a structured database;
determining at least one evaluation index for the at least one user by performing statistical analysis on the structured data;
comparing the at least one evaluation index with a benchmark value pre-defined for the at least one evaluation index; and
generating at least one report and at least one alert for at least one other user to evaluate the performance of the at least one user based on the comparison of the at least one evaluation index with the benchmark value.
